(19) United States
(12) Patent Application Publication
(10) Pub. No.: US 2026/0150018 A1
(43) Pub. Date: May 28, 2026

(54) METHOD FOR FAST MEDIUM ACCESS CONTROL RE-ESTABLISHMENT UPON RADIO LINK FAILURE FOR L1/L2 MOBILITY

(71) Applicant: Nokia Technologies Oy, Espoo (FI)

(72) Inventors: Hans Thomas HÖHNE, Espoo (FI); Guillaume DECARREAU, Munich (DE); Marvin MANALASTAS, Tulsa, OK (US); Faranaz SABOURI-SICHANI, Aalborg (DK); Xin ZHANG, Munich (DE); Sanjay GOYAL, Murray Hill, NJ (US); Rakash SIVASIVA GANESAN, Munich (DE)

(21) Appl. No.: 19/347,808

(22) Filed: Oct. 2, 2025

Related U.S. Application Data
(60) Provisional application No. 63/724,864, filed on Nov. 25, 2024.

(51) Int. Cl. H04W 36/00; H04W 74/0833; H04W 76/19

(52) U.S. Cl. CPC H04W 36/0079; H04W 74/0833; H04W 76/19

(57) ABSTRACT

An apparatus and method are provided for user equipment configured for medium access control mobility. The apparatus and method are implemented to adapt the user equipment to detect a radio link failure in a first cell, wherein the first cell is a source cell, cell (re-)selection is performed by the user equipment to select a second cell. A random access message is transmitted to the selected second cell. The user equipment receives from the selected second cell a random access response comprising a medium access control level message from the selected second cell and an uplink grant. The user equipment then, in response to determining that the selected second cell supports medium access control re-establishment, transmits toward the selected second cell a medium access control re-establishment request comprising user equipment identifiers including a source cell radio network temporary identifier, a source physical cell identification, and information to verify the user equipment identity.

### BACKGROUND

Radio link failures occur for a variety of reasons. In view of such failures, it is usually desired to re-establish and recover connections that have been lost.

By way of brief background, mobility procedures maybe carried out on lower layers L1/L2 or at the medium access control (MAC) level, such as lower-layer triggered mobility (LTM or L1/L2 mobility or L1/L2 triggered mobility) or MAC mobility/cell@MAC, respectively. For MAC mobility/cell@MAC environments, mobility management and user equipment (UE) configuration, and partial UE context, are maintained at MAC level.

For all such procedures, however, link failure presently leads to radio resource control (RRC) re-establishment, even where the UE recovers to a cell which supports MAC mobility/cell@MAC. In this regard, for MAC level mobility recovery, part of the UE context may be located at the MAC mobility manager of the last serving cell. In those cases, unnecessary delays are introduced by the involvement of RRC signaling in the RRC re-establishment process.

By way of further background, with reference to FIG. 1, an overall architecture 100 for separation of control plane gNB-CU-CP 102 and user plane gNB-CU-UP 104 is shown. It will be appreciated that dense networks have the benefit of an architecture which has a split among a centralized unit (CU) and distributed units (DUs) (e.g., a CU-DU split). In these cases, a gNodeB (gNB) centralized unit (gNB-CU) hosts RRC, SDAP and PDCP protocols of the gNB or RRC and PDCP protocols of the gNB that controls the operation of one or more gNB-DUs 106. The gNB-CU terminates the F1 interface connected with the gNB-DU. Further, a gNB distributed unit (gNB-DU) hosts RLC, MAC and PHY layers and its operation is partly controlled by gNB-CU. One gNB-DU supports one or multiple cells. One cell is supported by only one gNB-DU. The gNB-DU terminates the F1 interface connected with the gNB-CU. As used herein, the term “network node” may refer to, e.g. in case of 5G, any of a gNB, a gNB-CU, a gNB-DU, a gNB-CU-CP, or a gNB-CU-UP, or any combination of them.

A RAN (radio access network) node or network node such as, e.g. a gNB, base station, gNB-CU, or gNB-DU, or parts thereof, may be implemented using, e.g., an apparatus with at least one processor and/or at least one memory with processor-readable instructions (“program”) configured to support and/or provision and/or process CU and/or DU related functionality and/or features, and/or at least one protocol (sub-)layer of a RAN (radio access network), e.g. layer 2 and/or layer 3. It is intended that any description referring to a DU shall also be treated as though the description refers to a network node which supports at least one of DU functionality or a layer 2 protocol of a radio access network (RAN). It is intended that any description referring to a CU shall also be treated as though the description refers to a network node which supports at least one of CU functionality or a layer 3 protocol of a radio access network (RAN).

Lower-layer triggered mobility (LTM), also referred to as L1/L2 mobility, was introduced in 3GPP in Rel-18, where MAC-level communication was introduced besides the known RRC-level communication in handover procedure. MAC level mobility is being further developed to introduce mobility procedures at MAC and with minimal involvement of RRC.

MAC mobility could be said to be implemented in LTM where handover decisions are taken at MAC level. Other proposals differing from LTM have mobility-related configuration managed by MAC, and not RRC.

MAC MM is the entity that handles MAC mobility decisions, as well as configurations. It differs from RRC in that it is a control unit in addition to RRC, and below RRC. In a CU-DU split, it is located at the DU. A control unit at MAC level may be named as mobility manager at MAC, or MAC MM.

For clarity, a UE's context may be fetched by or provided to a target cell, e.g., via NGAP in the Handover Preparation Information message. In that sense, the UE context comprises various information elements. In MAC mobility, part of the RRC Reconfiguration will be directly configured to the UE by the MAC mobility management (MM). This means that, in the network, the latest version of part of the RRC Reconfiguration may reside with MAC mobility management and not with RRC. In one MAC mobility concept, the MAC related parameters are comprised in RRC Configuration and are provided by MAC with pointer to the corresponding IE/placeholder in an RRC configuration to the UE. The aspect of RRC configuration 200 comprising parts that are managed by MAC, e.g., MAC MM, is referred to as a UE MAC context and is visualized in FIG. 2. Examples for part of the configuration that are managed by MAC may be, for instance, the measurement configuration, e.g., config element 2.

In future communication systems, the DU may host the RRC as well as MAC layer functionality. In those future systems, it may be still possible to distinguish between lower layer/MAC layer mobility and RRC based mobility. This is because parts of mobility measurements and decisions/commands/signaling may be originated/signaled by the MAC layer or MAC mobility management or other parts of mobility by RRC. Thus, in the sequel, one may understand interchangeably “DU” as MAC layer mobility functionality, and “CU” as RRC layer mobility functionality.

As further background, radio link failure (RLF) describes the event where the UE loses connectivity to its serving cell. Handover failure (HOF) describes the event the UE was ordered by its serving cell to connect to a neighbor cell, but fails to do so. RLF is declared in the UE according to the mechanisms controlled by timer T310 and counter N310, in conjunction with T311 and N311, see 38.331, section 7.1.1 (Timers). In short, for N310 consecutive indication of lower layers of out-of-sync, a timer (T310) is started, which, when it expires, triggers an RRC re-establishment. HOF is declared if, after a certain time (given by the initial value of T304), handover has not been completed. The expiry of T304 triggers RRC re-establishment.

| Timer | Start | Stop | At expiry |
|---|---|---|---|
| T304 | Upon reception of | Upon successful completion | For T304 of MCG, in |
| | RRCReconfiguration | of random access on the | case of the handover |
| | message including | corresponding SpCell. | from NR or intra-NR |
| | reconfigurationWithSync | In case of a reconfiguration | handover, or path |
| | for the MCG which does | with sync without performing | switch from a L2 U2N |
| | not include sl- | random access procedure, | Relay UE to a NR cell, |
| | PathSwitchConfig, or upon | upon receiving a PDCCH | or a reconfiguration |
| | reception of | transmission addressed to C- | with sync without |
| | RRCReconfiguration | RNTI after first UL | performing random |
| | message including | transmission, for the same | access procedure, or an |
| | reconfigurationWithSync | HARQ process. | LTM cell switch |
| | for the SCG not indicated | In case of an LTM cell switch | procedure, initiate the |
| | as deactivated in the NR or | without performing a random | RRC re-establishment |
| | E-UTRA message | access procedure, upon | procedure; In case of |
| | containing the | receiving a PDCCH | handover to NR, |
| | RRCReconfiguration | transmission addressed to C- | perform the actions |
| | message or upon | RNTI after first UL | defined in the |
| | conditional reconfiguration | transmission, for the same | specifications |
| | execution i.e. when | HARQ process. | applicable for the |
| | applying a stored | Upon receiving an indication | source RAT. If any |
| | RRCReconfiguration | from lower layers of | DAPS bearer is |
| | message including | successful completion of | configured and if there |
| | reconfigurationWithSync. | Rach-less handover. | is no RLF in source |
| | Also, for the MCG and | For T304 of SCG, upon SCG | PCell, initiate the |
| | SCG upon an indication | release. | failure information |
| | from lower layer that an | | procedure. |
| | LTM cell switch procedure | | For T304 of SCG, |
| | is triggered and, for the | | inform network about |
| | MCG, upon performing an | | the reconfiguration |
| | LTM cell switch procedure | | with sync failure by |
| | following cell selection | | initiating the SCG |
| | performed while timer | | failure information |
| | T311 is running. | | procedure as specified |
| | | | in 5.7.3. |
| T310 | Upon detecting physical | Upon receiving N311 | If the T310 is kept in |
| | layer problems for the | consecutive in-sync | MCG: If AS security is |
| | SpCell i.e. upon receiving | indications from lower layers | not activated: go to |
| | N310 consecutive out-of- | for the SpCell, upon receiving | RRC_IDLE else: |
| | sync indications from lower | RRCReconfiguration with | initiate the MCG |
| | layers. | reconfigurationWithSync for | failure information |
| | | that cell group, upon reception | procedure as specified |
| | | of MobilityFromNRCommand, | in 5.7.3b or the |
| | | upon the reconfiguration of | connection re- |
| | | rlf-TimersAndConstant, upon | establishment |
| | | initiating the connection re- | procedure as specified |
| | | establishment procedure, upon | in 5.3.7 or the |
| | | conditional reconfiguration | procedure as specified |
| | | execution i.e. when applying a | in 5.3.10.3 if any DAPS |
| | | stored RRCReconfiguration | bearer is configured. |
| | | message including | If the T310 is kept in |
| | | reconfigurationWithSync for | SCG, Inform E- |
| | | that cell group, and upon | UTRAN/NR about the |
| | | initiating the MCG failure | SCG radio link failure |
| | | information procedure. | by initiating the SCG |
| | | Upon SCG release, if the T310 | failure information |
| | | is kept in SCG. | procedure as specified |
| | | | in 5.7.3. |

Further, TS 38.331 specifies that RLF and its recovery is triggered by MAC RACH problems, as well as reaching the maximum number of RLC retransmissions.

TS 38.331, section 5.3.7, describes the procedure of RRC re-establishment, shown in FIG. 3 which illustrates a successful RRC connection re-establishment procedure based thereon. As shown, the UE 305, which no longer has a connection to a cell, selects a new cell in the network 310 based on measurements.

After cell selection, the UE 305 establishes contact with the new cell, and as part of the RRC re-establishment, provides the identification (ID) of the previous cell and the ID of the UE in the previous cell to the network.

As a next step, the newly selected cell will attempt to retrieve the UE context of the previous serving cell of the UE 305. The UE context comprises the UE's RRC configuration. If the UE context retrieval is successful, RRC re-establishment can be performed. If not, RRC connection setup has to be performed, which will involve more signaling and is slower.

At RRC Re-establishment, the UE provides its IDs (C-RNTI, PCI, shortMAC-I), allowing the network to ascertain the identity of the UE and to retrieve the UE context, see TS 38.331 “Re-establishment”

Before the UE can signal to the newly selected cell the mentioned IDs, the UE needs to synchronize with the network on the physical level. This can be accomplished with contention based random access (CBRA), or contention free random access (CFRA).

FIG. 4A shows the sequence of steps for CBRA. For clarity throughout this application, descriptive reference to a “line” (such as, for example, line 1) in the drawings is a used to refer to items, actions or states such as messages sent or received, actions carried out by an entity or a description of a state of an entity. With reference back to FIG. 4A, After establishing downlink (DL) sync (not shown in the diagram), at line 1, the UE 405 sends a random access channel (RACH) preamble to the network 410, also called RA-RNTI. The network replies, at line 2, with the Random Access Response (RAR) containing temporary C-RNTI (TC-RNTI), timing advance (TA) and an uplink (UL) grant for msg 3. At line 3, message 3 contains an RRC message, such as RRC Connection setup or RRC re-establishment request. At line 4, Msg 4 by the network confirms that the network has received the UE's data, and is assigning the UE its unique C-RNTI. This step is necessary as, in principle, it may happen that another UE has also performed RACH—contending for access—and the UE cannot be sure that the network was replying in msg 2 to itself or someone else. Thus, the UE's access contention is resolved in message 4. We note that message 4 is integrity protected with K_int. Thus, message 1 is a preamble. Message 2 is a MAC message. Message 3 is an RRC message. Message 4 is a contention resolution that may have forms such as 1) contention resolution success is declared if the PDCCH in message 4 contains the UE's C-RNTI, and/or 2) message 4 contains a MAC control element (CE) with contention resolution.

In CFRA, see FIG. 4B, the UE 415 has been pre-configured, at line 0, with a specific RACH preamble (used in message 1). Thus, the contention resolution of line 4 will not be needed by the network 420. At line 2, the message 2 (RAR) will already contain the C-RNTI for the UE. This access is considered faster because no contention resolution has to be performed.

For CBRA, the message 2 (RAR) is a MAC message and has format as shown in TS 38.213 and TS 38.321 FIG. 6.1.5-3, or shown in the alternative visualization of MAC RAR (addressing multiple UEs in the sub-headers) in FIG. 5—showing an example message 500.

The MAC subPDUs contained in the RAR MAC PDU are addressing different UEs which have sent a RACH preamble in the same RACH opportunity and, therefore, are addressed by the same RA-RNTI.

The RAR MAC subheader and RAR MAC payload PDU are defined in TS38.321 section 6.2.2 and 6.2.3. The RAR payload's UL grant for the PUSCH is explained in TS 38.213 for instance in table 8.2-1.

The message (line 3) sent by the UE is an RRC message name RRCReestablishmentRequest (see TS 38.331) and its contents are as shown in below table:

The size of the components of this RRC message is as follows:

| IE name | Type | bits |
|---|---|---|
| C-RNTI | RNTI-Value INTEGER | 16 |
| | (0..65535) | |
| physCellId | PhysCellId ::= INTEGER | 10 |
| | (0..1007) | |
| shortMAC-I | ShortMAC-I ::= BIT | 16 |
| | STRING (SIZE (16)) | |
| reestablishmentCause | ENUMERATED { | 2 |
| | reconfigurationFailure, | |
| | handoverFailure, | |
| | otherFailure, spare1} | |
| Spare | | 1 |
| Total | | 45 |

The RRCRestablishRequest encoded in ASN.1 has size 45 bits.

Contention resolution procedural text (line 4) is described in TS 38.321, section 5.1.5. One learning from the text is that the MAC layer examines the MAC PDUs for the MAC control element (CE) and declares contention resolution successful or not. The contention resolution MAC CE structure and contents are further defined in TS 38.321 section 6.1.3.3.

L1/2 Triggered Mobility (LTM) [TS 38.300, in section 9.2.3.5.2], is split in four phases. The first phase is preparation during which the serving CU identifies the potential targets based on the L3 measurement reports, prepares the target cells and shares the target cell configurations with the UE. The second phase is early synchronization, during which the serving DU asks the UE to perform TA acquisition for a specific target cell, and may do that for several target candidate cells. The third phase is execution, during which the serving DU decides (considering L1 measurements) on the target cell and asks the UE to switch to that. The latter switches to that cell and starts receiving data from it. The fourth phase is completion, during which the UE context is released from the prepared cells. This is optional and the UE context may be kept in case of Dynamic Switching. It is up to the CU on how long the UE context will be maintained.

In case the UE maintains the configurations of the target cell, it is allowed to perform multiple/subsequent LTM operations. This is called subsequent LTM.

In the current practice (e.g., 5G), a DU is responsible for configuring lower layer parameters. A CU would request those parameters from the DU when the CU decides to configure LTM. With reference to FIG. 6 which shows an LTM procedure, the circled part on the upper right side of the diagram is the process when the CU requests those parameters from the DU and packs them together with high level configuration in a complete RRC reconfiguration message in line 8 later.

Another known recovery technique is LTM recovery. In case of LTM cell switch failure and the UE going into cell-selection, the UE may directly use parameters of LTM candidates for cell access.

It should be appreciated that, for LTM recovery to happen, the UE needs to have been configured with the selected cell configuration prior to RLF, unlike in re-establishment. Further, the UE needs to have had measured and reported the selected cell earlier (in the above mentioned first phase), for the network to be able to provide the LTM candidate configuration which is then used for recovery. The selected cell needs to have been prepared with the UE context for the recovery to happen. Further, for LTM recovery, the UE behaves towards the selected cell as with a cell switch, that is, in the cell access, it provides as ID its C-RNTI only.

Another known recovery technique is Conditional Handover (CHO) recovery. If the UE, while T311 (RRCRestablishment) is running, selects to a cell which is part of the CHO candidates, it can apply that configuration.

As with LTM recovery, also here, the UE needs to have been configured with the selected cell configuration for the recovery to happen, unlike in re-establishment.

Another known recovery technique is Baseline HO (BHO)/L3 handover. In case of RLF or HOF, the UE selects the best available cell and then performs RRC Reestablishment. The best available cell search may start with previous serving cell.

Another known recovery technique is non-mobility related recovery. The UE will perform Beam Failure Detection (BFD), and Beam Failure Recovery (BFR) in the serving cell.

With reference to FIG. 7 which illustrates a MAC-I calculation, when the UE sends a RACH message 3 “RRC Re-establishment”, it contains a field MAC-I. The procedure to compute that value (e.g., according to TS 38.331 and 33.501) is as follows:
2> set the shortMAC-I to the 16 least significant bits of the MAC-I calculated:
3> over the ASN.1 encoded as per clause 8 (i.e., a multiple of 8 bits) VarShortMAC-Input;
3> with the K_{RRCint} key and integrity protection algorithm that was used in the source PCell (reconfiguration with sync or mobility from NR failure) or of the PCell in which the trigger for the re-establishment occurred (other cases); and
3> with all input bits for COUNT, BEARER and DIRECTION set to binary ones;

Beam Failure detection and recovery (e.g. BFR) procedure is specified in TS 38.321-5.17. If the UE detects a predefined number of beam failures, a BFR process is triggered with the candidate beam using PRACH, labeled “BFR Request”. The network replies to the RACH with RAR, and sends the RAR via downlink control information (DCI) in the search space specified by recoverySearchSpaceId.

Unlike in the RACH for RRC Re-establishment, no message 3 is sent.

### BRIEF DESCRIPTION

In accordance with one aspect of the present exemplary embodiments, an apparatus implemented in user equipment comprises at least one processor; and, at least one memory having stored thereon code or instructions that, when executed by the at least one processor, cause the apparatus to: detect a radio link failure in a first cell, wherein the first cell is a source cell, perform cell (re-)selection by the user equipment to select a second cell, transmit a random access message to the selected second cell, receive via the selected second cell a random access response comprising a medium access control level message from the selected second cell and an uplink grant, and in response to determining that the selected second cell supports medium access control re-establishment, transmit towards the selected second cell a medium access control re-establishment request comprising user equipment identifiers including a source cell radio network temporary identifier, a source physical cell identification, and information to verify the user equipment identity.

In accordance with another aspect of the presently described embodiments, the apparatus is caused to receive from a network node information relating to performance of medium access control re-establishment

In accordance with another aspect of the presently described embodiments, the information relating to performance of medium access control re-establishment comprises a list of cells configured to perform medium access control re-establishment.

In accordance with another aspect of the presently described embodiments, the information relating to performance of medium access control re-establishment comprises information on medium access control resources to perform medium access control re-establishment.

In accordance with another aspect of the presently described embodiments, the information relating to performance of medium access control re-establishment comprises information allowing for receipt of a type identifier for medium access control re-establishment.

In accordance with another aspect of the present exemplary embodiments, the apparatus is further caused to receive from the selected second cell an acknowledgement of the medium access control re-establishment request.

In accordance with another aspect of the present exemplary embodiments, the apparatus further caused to receive context resolution from the selected second cell.

In accordance with another aspect of the present exemplary embodiments, the apparatus is further caused to receive a context update from the selected second cell.

In accordance with another aspect of the present exemplary embodiments, the apparatus is further caused to establish a radio link connection to the selected second cell.

In accordance with another aspect of the present exemplary embodiments, the network node may include a control unit comprising a medium access control mobility manager, e.g. located in a DU supporting the first cell or within a central unit in a CU.

In accordance with another aspect of the present exemplary embodiments, the information to verify the user equipment identity is a ShortMAC element.

In accordance with another aspect of the presently described embodiments, the apparatus is further caused to determine any of the following conditions: dual active protocol stack (DAPS) handover, conditional handover (CHO) or LTM.

In accordance with another aspect of the present exemplary embodiments, a method is implemented in user equipment, the method comprising detecting a radio link failure in a first cell, wherein the first cell is a source cell, performing cell (re-)selection by the user equipment to select a second cell, transmitting a random access message access to the selected second cell, receiving via the selected second cell a random access response comprising a medium access control level message from the selected second cell including a temporary cell radio network temporary identifier, timing advance information, and an uplink grant, and in response to determining that the selected second cell supports medium access control re-establishment, transmitting towards the selected second cell a medium access control re-establishment request comprising user equipment identifiers including a source cell radio network temporary identifier, a source physical cell identification, and information to verify the user equipment identity.

In accordance with another aspect of the presently described embodiments, the method further comprises receiving from a network node information relating to performance of medium access control re-establishment.

In accordance with another aspect of the presently described embodiments, the information relating to performance of medium access control re-establishment comprises a list of cells configured to perform medium access control re-establishment.

In accordance with another aspect of the presently described embodiments, the information relating to performance of medium access control re-establishment comprises information on medium access control resources to perform medium access control re-establishment.

In accordance with another aspect of the presently described embodiments, the information relating to performance of medium access control re-establishment comprises information allowing for receipt of a type identifier for medium access control re-establishment.

In accordance with another aspect of the present exemplary embodiments, the method further comprises receiving from the selected second cell an acknowledgement of the medium access control re-establishment request.

In accordance with another aspect of the present exemplary embodiments, the method further comprises receiving context resolution from the selected second cell.

In accordance with another aspect of the present exemplary embodiments, the method further comprises receiving a context update from the selected second cell.

In accordance with another aspect of the present exemplary embodiments, the method further comprises establishing a radio link connection to the selected second cell.

In accordance with another aspect of the present exemplary embodiments, the network node may include a control unit comprising a medium access control mobility manager, e.g. located in a DU supporting the first cell or within a central unit in a CU.

In accordance with another aspect of the presently described embodiments, the method further comprises determining any of the following conditions: dual active protocol stack (DAPS) handover, conditional handover (CHO) or LTM.

In accordance with another aspect of the present exemplary embodiments, a non-transitory computer readable medium having stored thereon code or instructions that, when executed by a processor, causes an apparatus to detect a radio link failure in a first cell, wherein the first cell is a source cell, perform cell (re-)selection by the user equipment to select a second cell, transmit a random access message to the selected second cell, receive via the selected second cell a random access response comprising a medium access control level message from the selected second cell and an uplink grant, and in response to determining that the selected second cell supports medium access control re-establishment, transmit towards the selected second cell a medium access control re-establishment request comprising user equipment identifiers including a source cell radio network temporary identifier, a source physical cell identification, and information to verify the user equipment identity.

In accordance with another aspect of the present exemplary embodiments, an apparatus implemented in user equipment comprises at least one processor and at least one memory having stored thereon code or instructions that, when executed by the at least one processor, cause the apparatus to detect a radio link failure in a first cell, wherein the first cell is a source cell, perform cell reselection by the user equipment to select a second cell, determine any of the following conditions: dual active protocol stack (DAPS) handover, conditional handover (CHO) or LTM, initiate medium access control re-establishment based on determining that the selected second cell supports medium access control re-establishment, and initiate radio resource control re-establishment based on determining that the selected second cell does not support medium access control re-establishment.

In accordance with another aspect of the present exemplary embodiments, a method implemented in user equipment comprises detecting a radio link failure in a first cell, wherein the first cell is a source cell, performing cell reselection by the user equipment to select a second cell, determining any of the following conditions: dual active protocol stack (DAPS) handover, conditional handover (CHO) or LTM, initiating medium access control re-establishment based on determining that the selected second cell supports medium access control re-establishment, and initiating radio resource control re-establishment based on determining that the selected second cell does not support medium access control re-establishment.

### BRIEF DESCRIPTION OF THE DRAWINGS

FIG. 1 illustrates prior technology;

FIG. 2 illustrates prior technology;

FIG. 3 illustrates prior technology;

FIGS. 4A and 4B illustrate prior technology;

FIG. 5 illustrates prior technology;

FIG. 6 illustrates prior technology;

FIG. 7 illustrates prior technology;

FIG. 8 illustrates an example according to the presently described embodiment;

FIG. 9 illustrates an example according to the presently described embodiment;

FIG. 10 illustrates an example according to the presently described embodiment;

FIG. 11 illustrates an example according to the presently described embodiment;

FIG. 12 illustrates an example according to the presently described embodiment;

FIG. 13 illustrates an example according to the presently described embodiment;

FIG. 14 illustrates an example according to the presently described embodiment;

FIG. 15 illustrates an example according to the presently described embodiment;

FIG. 16 illustrates an example according to the presently described embodiment;

FIG. 17 illustrates an example according to the presently described embodiment;

FIG. 18 illustrates an example according to the presently described embodiment;

FIG. 19 illustrates an example according to the presently described embodiment; and,

FIG. 20 illustrates an example according to the presently described embodiment.

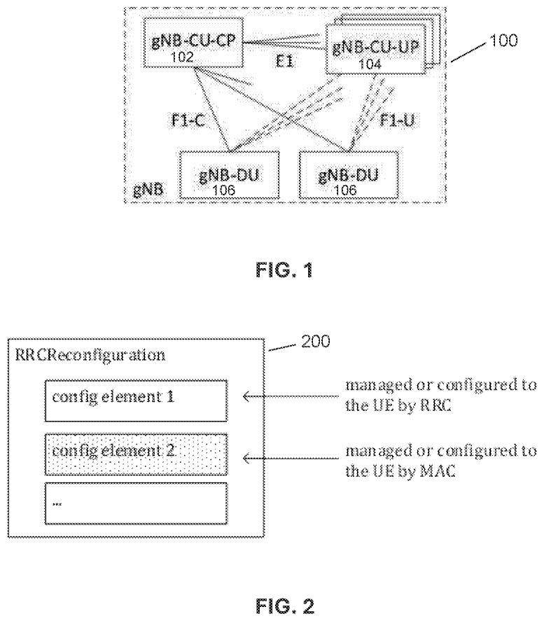

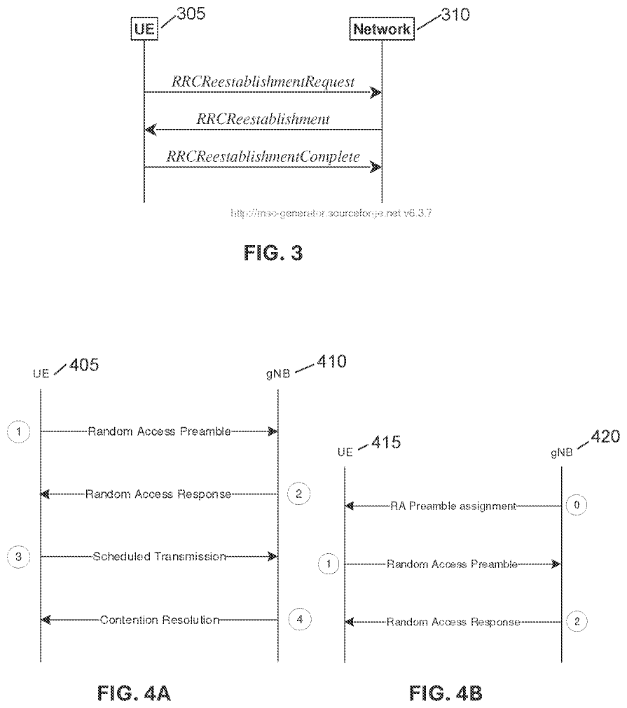

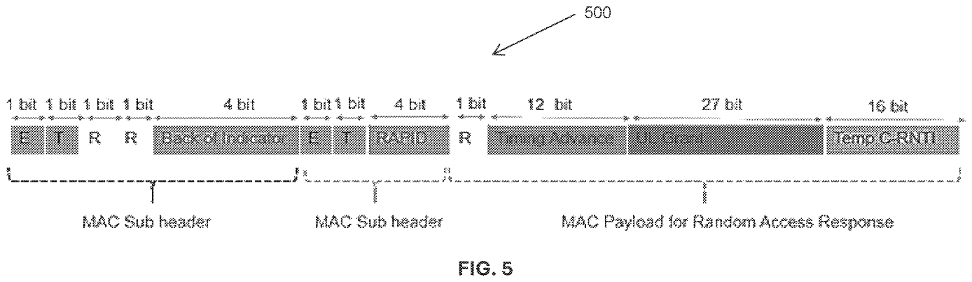

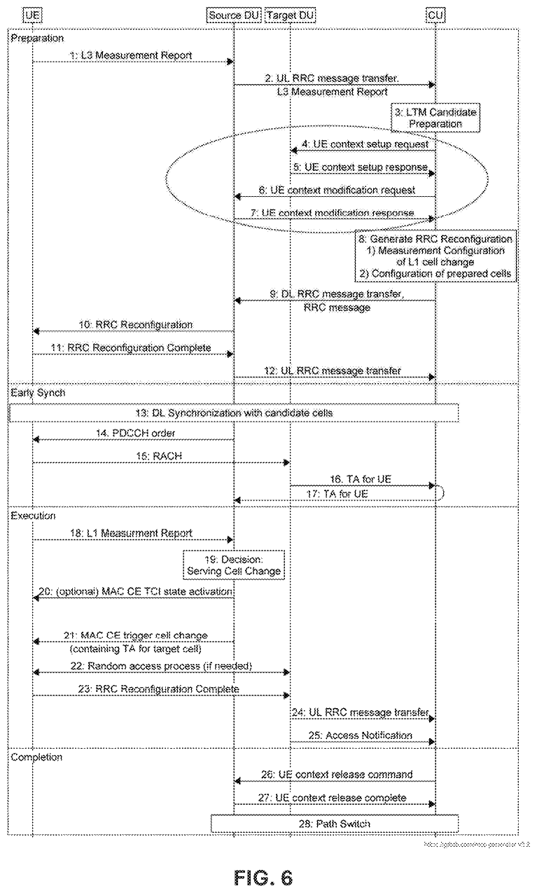

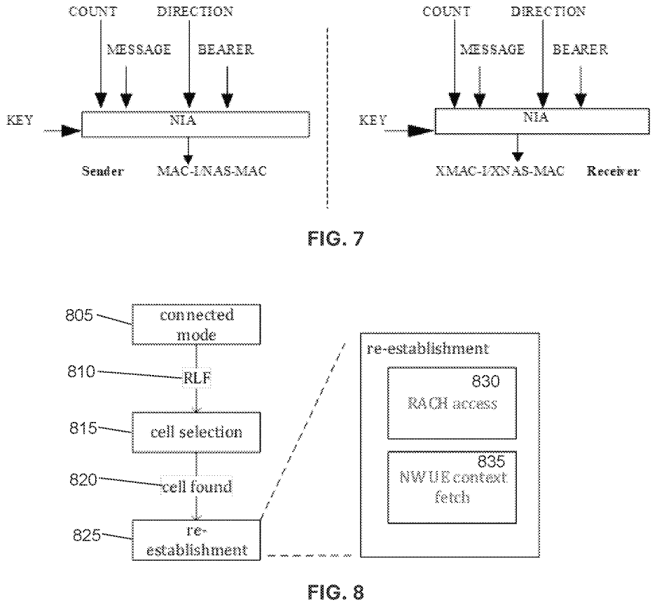

### DETAILED DESCRIPTION

According to the presently described embodiments, a medium access control (MAC) level re-establishment procedure is provided. In at least one form, the presently described embodiments provide an approach for failure recovery at MAC level and thus simplify and speed-up the procedure. The described approach of the presently described embodiments, in at least one form, has advantages such as, for example, use of a RACH access type, the option to perform blind recovery, and the option to not involve RRC and, thereby, save time.

According to the presently described embodiments, in at least one form, under certain conditions, a MAC re-establishment procedure is triggered by RLF that involves only the MAC layer. In this regard, for example, UE is configured for MAC re-establishment under certain conditions, such as having the capability to do so, or being associated with a DU that enables it to do so, or selecting to a cell at the same DU, or selecting to a cell that it knows (by configuration) it supports MAC re-establishment. Upon detecting RLF, the UE initiates connection re-establishment at MAC level—sometimes referred to herein as MAC re-establishment (as opposed to the RRC re-establishment procedure). In at least one implementation of the presently described embodiments, a MAC re-establishment message design is provided. In case of an inter-DU cell, a solution for UE context fetch is provided.

As noted above, the example method of MAC re-establishment according to the presently described embodiments is different from RRC re-establishment. MAC re-establishment terminates RACH msg 3 in MAC, whereas in RRC re-establishment, RACH msg 3 goes to RRC, which introduces some delay. For cell@MAC, the case for a re-establishment procedure is a situation where there are many intra-DU cells, but the UE has not been given configurations to all of them. The reason for such approach would be to reduce the amount of configurations the UE needs to hold at a given time. While the UE does not have all cells' configurations, it is configured with the IDs of all cells that support MAC re-establishment

In general, it should be appreciated that re-establishment is different from cell switch or recovery. For the former, the UE and target do not know each other's configuration. More specifically, the difference of MAC re-establishment compared to LTM recovery is that, in LTM, recovery is carried out only for target cells which have been configured to the UE as LTM candidate cells. In MAC re-establishment, the UE does not have the target configuration. This is also reflected in that, in MAC re-establishment, the UE needs to provide a complete ID to the target such that it can recover the UE MAC context. In LTM recovery, the UE C-RNTI will be sufficient. If the selected cell after an RLF is not among the candidates, an RRC re-establishment will be performed, different from the proposed MAC re-establishment.

Recall, with reference to FIG. 8, the re-establishment process happens as a sequence from a UE operating in a connected state/mode 805, to radio link failure (RLF) detection 810, further a cell selection 815, a finding a cell 820 and performing connection re-establishment 825, where “connection” refers to the UE being able to communicate with the selected cell. The re-establishment has two parts: the UE accessing the cell via RACH (at 830), and the network retrieving the last valid UE context for the UE (at 835) (such that the UE does not need to undergo a full configuration by the target cell).

According to the presently described embodiments, in at least one form, at least two areas where new techniques can be introduced, namely, for example, in RACH access at a target cell (design modifications for CBRA RACH messages 1, 2, 3, 4) and in network handling of the UE context in a MAC mobility failure recovery.

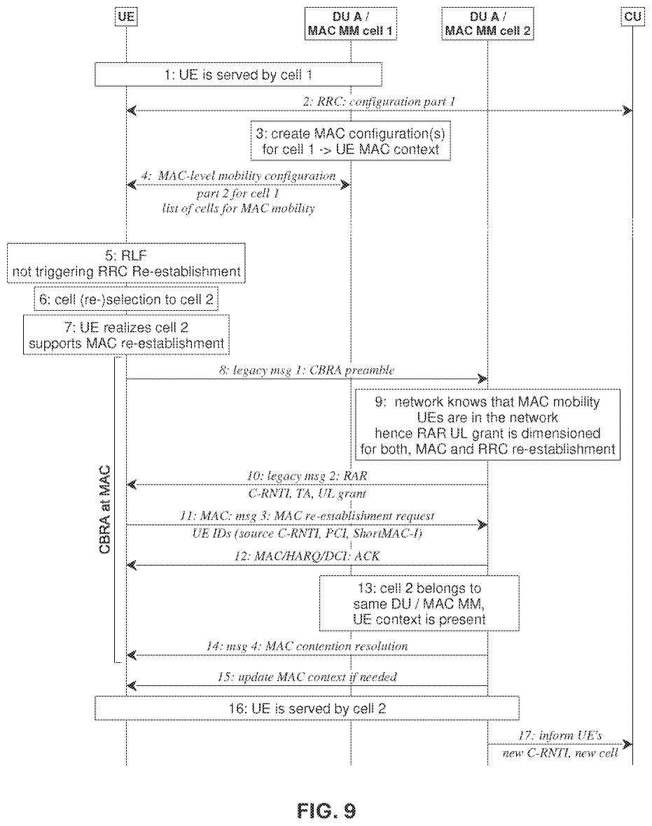

More specifically, with reference now to FIG. 9, MAC re-establishment may be triggered by an RLF. In that case, no new trigger mechanisms need to be introduced, but old trigger mechanisms, in at least one form, are redirected.

Note that RLF is currently triggered when a maximum number of RLC retransmissions is reached, or MAC RACH problems occur or a number of consecutive OoS indications reach the maximum number. Each of these are identified directly within the DU. Hence, it is proposed that in future 6G, RLF shall always trigger MAC-re-establishment instead of RRC re-establishment for intra-CU scenarios.

As an alternative to triggering MAC re-establishment by an RLF, a MAC re-establishment trigger may be created that happens prior to an RLF. Specifically, it could be triggered for fewer RLC re-tx.

Further, and additionally, MAC re-establishment triggering could also be conditioned to occur only when an intra-DU cell or MAC-mobility configured target cell has been selected, or alternatively, when intra-DU or MAC mobility target cells are among the strongest measured neighbor cells.

In intra-DU recovery, it is assumed that cells offering MAC re-establishment are known to the UE, e.g., by prior configuration. This enables leaving the design of RACH messages 1 and 2 unchanged and avoids RACH allocations reserved for MAC re-establishment. The RACH Message 3 design is explained below.

Referring back to FIG. 9, in a first embodiment where the UE knows the target cell is capable of MAC re-establishment, the cell selected in RLF does not have the UE context, nor does the UE have the cell's configuration. Instead, the UE knows only a list of cell IDs which support MAC re-establishment, whereas the target knows only that there might be UEs attempting to perform MAC re-establishment.

In lines 2, 3, and 4, the MAC level mobility is configured, where part of the UE configuration/context is managed by the RRC (e.g. in CU), and part by the MAC layer (e.g. in DU). The RRC serves to configure non-cell specific parameters, whereas the MAC configuration delivers cell-specific parameters such as measurement configuration. It should be appreciated that the DU is in possession of at least part of the UE's configuration, and hence, part of the UE's context which will be later needed for MAC re-establishment.

There is no need to configure MAC re-establishment specific resources. In line 2, RRC configuration is provided to the UE, containing e.g., non-cell specific parameters. This message may also indicate what parameters the UE should expect to obtain from the MAC level. In line 3, the MAC level creates configurations for this cell and other cells. In line 4, the MAC (or RRC, not shown in the diagram) level delivers the generated configuration (part 2) to the UE. Alternatively, line 3 could also happen before line 2, and then MAC configurations could be also delivered to the UE via CU using RRC.

Message 4 (or, at line 4) contains a list of cells where the UE can perform MAC re-establishment, where the list may contain more cells than the list comprising cell configurations. In line 5, RLF triggers the recovery procedure. However, instead of triggering RRC re-establishment, the new MAC-recovery procedures are started. We note that the RRC connection is not affected by triggering the RLF. In line 6, the UE performs cell re-selection similar to what happens preceding an RRC reestablishment, that is, for example, the UE measures available cells and selects the best cell. In line 7, the UE realizes that the cell it selected, cell 2, is part of the list it acquired from line 4 (or, Message 4). That is, the UE may perform MAC re-establishment. In line 8, considering a CBRA approach, the UE initiates access with RACH message 1. In line 9, at this point, the network is not yet aware of the UE's identity. Therefore, the network does not yet know whether this is a UE that attempts MAC re-establishment or RRC re-establishment. The network is meant to provide an uplink (UL) grant for UE RACH message 3. In some forms of the presently described embodiments, the message 3 would have same size for an MAC re-establishment and an RRC re-establishment. In other cases, where, e.g., reserved unused bits have been removed, that may not be so. In those cases, the DU will configure the UL grant provided in the next message to accommodate either of them. In line 10, the target cell replies with a MAC level message 2, providing Temporary C-RNTI, TA, and UL grant for the UE's next transmission. In line 11, the UE replies with what would be message 3 in a conventional CBRA; however, unlike the traditional message 3 communicated via the RRC layer, this message is sent by the UE MAC layer, and received by the MAC at the gNB. Message design details are described below. In line 12, the network shall acknowledge the reception of the message 10. In line 13, the MAC mobility manager for Cell 2 determines it has the MAC UE context. In line 14, contention resolution is provided. In line 15, the network updates the UE with changes to the context, if needed. The network does so, in this example, using MAC signaling. Of course, this feature may be bundled with the action at line 14. In line 16, at this point, the UE is connected to the cell 2 and may comprise a “config complete” message from UE to the MAC level. In line 17, the CU is informed of the UE's new cell, and C-RNTI.

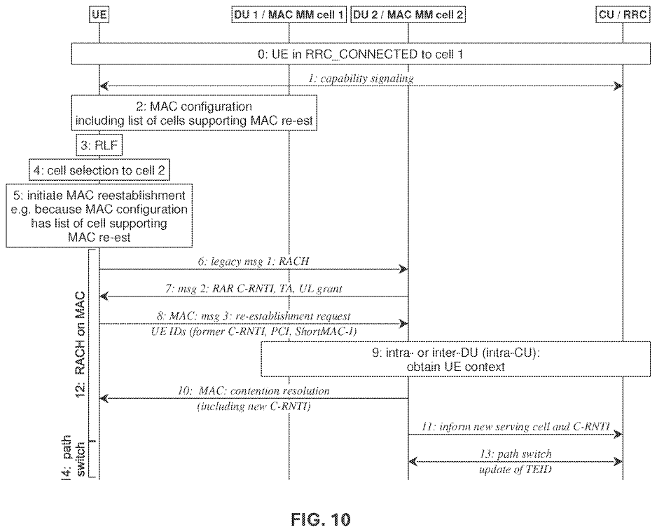

With reference to FIG. 10, as shown, the signaling for inter-DU re-establishment without dedicated RACH resources is similar to the intra-DU scenario. Additionally, a DU context fetch needs to be carried out, which may involve the CU. In line 2, UE is provided with list of cells to which MAC re-establishment is possible. In line 9, context fetch is explained in a separate section further below. In line 13, as the CU is now aware of the UE ID along its new serving cell, the tunnel end points for the bearers can be updated to point to the new DU.

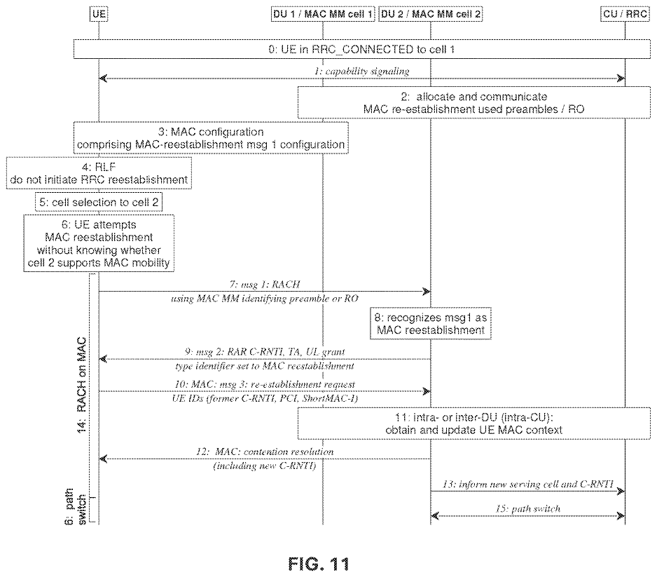

In the example of FIG. 11, the UE does not need to know whether the selected cell for recovery supports MAC mobility or not (e.g., blind recovery). In FIG. 11, re-establishment is initiated at the MAC level, the UE does not know the target cell but the target cell recognizes MAC re-establishment initiation in an intra-CU scenario. Moreover, here a new RACH design for messages 1, 2, and 3 are used that are terminated by the MAC MM at the recovery cell. In line 0, the UE has an RRC connection in Cell 1. In line 1, the UE and network exchange capability signaling, where the UE indicates support of MAC re-establishment. This signaling can also be introduced to all other variants. For brevity, it is shown only here. In line 2, MAC re-establishment message 1 resources (preambles and RO that will be used) are allocated, e.g., by the CU and made known in neighbors of the serving cell. In line 3, the UE is made aware of what MAC re-establishment resources in case of recovery. In this embodiment, the UE does not know whether neighbor cells support MAC mobility or MAC re-establishment. Instead, it is configured to perform a MAC re-establishment rather than an RRC reestablishment by default. In line 4, RLF is triggered as before, at expiry of timers like T304, T310, reaching of maximum number of re-transmissions at the RLC layer. The corresponding mechanisms are not triggering RRC-RLF. In other words, the RRC-RLF is redirected to MAC-RLF and not RRC recovery mechanisms.

We note that RLC is one layer above MAC, and RLC failure would need to be communicated from RLC to the MAC-level mobility management. This seems possible where the RLC is located in the same physical unit as MAC, namely a DU (in a split architecture) or gNB (in a monolithic architecture). In line 5, the UE performs cell selection (to cell 2). In line 6, the UE blindly attempts MAC re-establishment. Recall that the UE in this embodiment does not know whether the selected cell supports MAC re-establishment. In line 7, following its configuration, the UE starts the MAC re-establishment with the dedicated message 1 (e.g. preamble chosen from a dedicated pool or RO), which was configured in line 3. In lines 8 and 9, the network recognizes the message 1 as MAC re-establishment, and it replies with a RAR. For fail safe operation, the network now should send a backward compatible RAR and also indicate to the UE that MAC re-establishment is to be used. Thus, the RAR contains a novel indication to proceed with MAC re-establishment. For example, an explicit one-bit field (e.g., type identifier) configurable between a first value and a second value may be provided in the RAR. In the first value, the field may indicate the UE to send a MAC re-establishment request. In the second value, the field may indicate the UE to send an RRC re-establishment request. This may be accomplished by for instance using a reserved bit R of the MAC RAR payload. The UL grant provided here is about whether the network expects a message 3 as RRC or MAC re-establishment request.

In line 10, UE sends message 3 as a MAC message. The network acknowledges the reception of the message 10 (see RACH message 3 design: If message 10 fits into a single Transport Block (TB), a Hybrid Automatic Repeat Request (HARQ) Acknowledgement (ACK) is sufficient. If message 10 does not fit into a single TB, the network acknowledges using DCI or a downlink (DL) MAC CE. The UE resends this MAC CE until it has received a positive acknowledgement (ACK) (or timer or re-tx count and then go again into cell-reselection). Alternatively, the UE shall resend this message until it has received its RACH message 4 from the network.

In line 11, the network performs UE context retrieval for MAC mobility. The exact messages and variants are detailed further below relating to a UE context fetch. Here, it is assumed that MAC mobility may continue without RRC change, hence CU/RRC is not involved.

In line 12, the recovery cell's MAC MM replies with contention resolution. It may also comprise a re-establishment confirmation message and updates to the UE's MAC configuration. The contention resolution also contains the UE's new Cell Radio Network Temporary Identifier (C-RNTI).

The following are typically present for a successful handover and are listed for completeness. In line 13, the target DU informs the CU about the UE's cell change. In line 15, path switch is carried out. TEIDs are updated.

It should be appreciated that, after the UE's access to the target cell, further configuration changes may be carried out. In cell@MAC, some of those configuration changes may be done by the DU, or by the CU. Configuration changes may be those of measurement configuration or other RRC configurations.

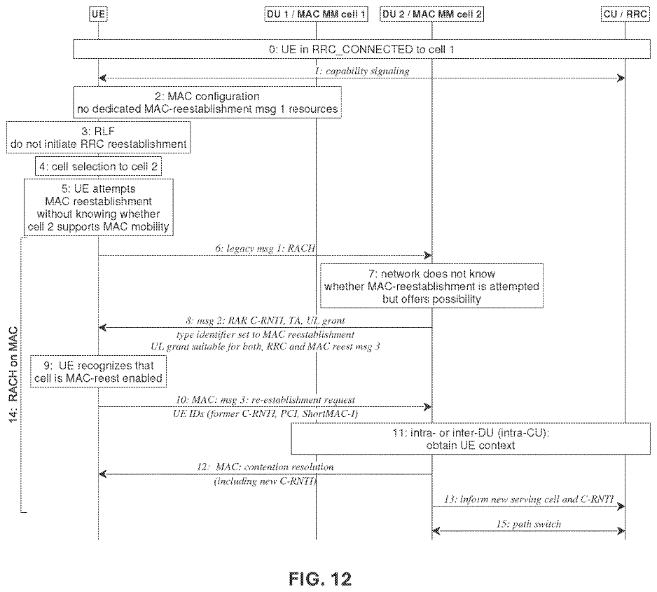

In FIG. 12, an inter-DU MAC re-establishment without dedicated RACH resources is illustrated. This example shows the UE is not aware of recovery cell configurations, and recovery cells are not prepared. Nevertheless, the UE uses a legacy RACH message. In line 7, the network blindly offers the incoming UE a MAC re-establishment. Consequently, the network provided UL grant for the UE's RACH message 3 is large enough for the UE to either send a MAC re-establishment or an RRC re-establishment. In line 8, the network replies with a RAR which has type identifier set to MAC re-establishment.

This process involves using the proposed RAR design where legacy UEs will ignore the reserved bit—which serves as a type identifier in the new design.

In case of (UE-) blind MAC re-establishment, it may happen that the recovery cell is not available for MAC mobility, or MAC re-establishment. Further, failure for transmission of messages 1 or 2 may occur.

In one failure case, the UE attempts to use resources for RACH message 1 which are not monitored by cell 2. In that case, the UE will reach the maximum number of message 1 transmissions and not receive a message 2 RAR from the network, and the UE has to attempt normal CBRA. This failure case is not shown here.

In one failure case, the network monitors the RACH resources that the UE is using but does not recognize message 1 as MAC re-establishment and therefore replies with a legacy RAR (type identifier set to “RRC re-establishment”).

In one failure case, the network monitors the RACH resources that the UE is using, and recognizes message 1 as MAC re-establishment, but the cell does not have the ability to support MAC mobility, and therefore the network replies with a legacy RAR.

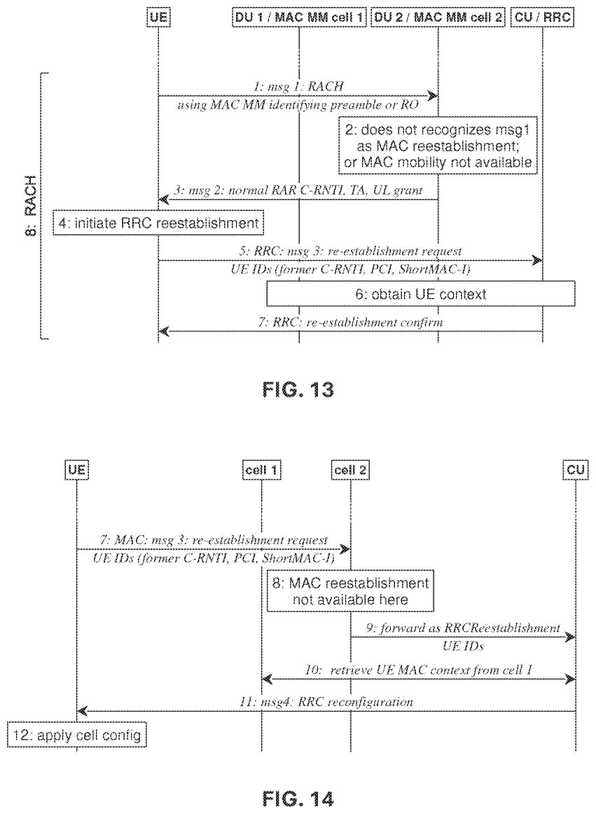

In those cases, the signaling in FIG. 13 will occur, where the UE initiates a fallback to legacy message 3 RRCReestablishment. A new RRC Re-establishment cause value may be defined “MACReestFailure”, or the existing cause “otherFailure” may be used.

Another variant for failure handling is that, if message 3 was a MAC re-establishment request while the network recognizes the message, it does not support it. In that case, the network forwards the request to RRC for RRC reconfiguration at the network, see FIG. 14, line 9.

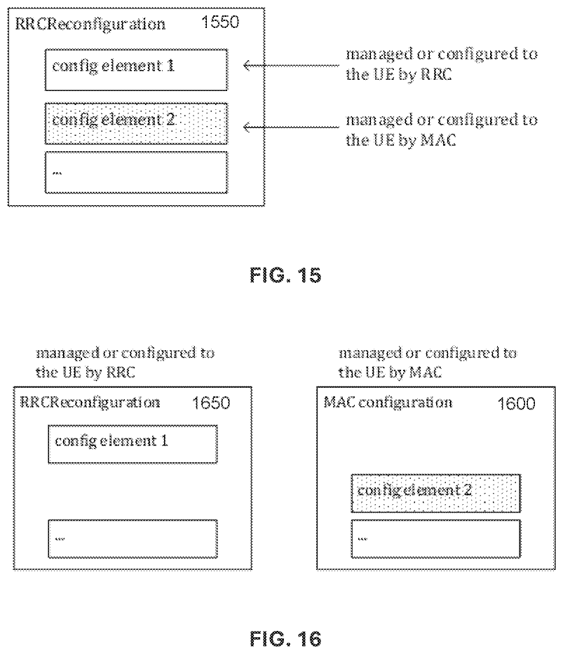

The presently described embodiments, in at least one form, provide means for failure recovery at the MAC level and hence simplify and speed-up the procedure. In one example, the MAC related parameters comprised in RRCReconfiguration are provided by MAC with pointer to the corresponding IE/placeholder in an RRC configuration 1550 received by RRC—an example version of such a UE MAC context is shown in FIG. 15.

In an alternative proposal for UE MAC context, the MAC configuration 1600 is being kept separate from RRC Reconfiguration 1650, as shown in FIG. 16.

The MAC context fetch is needed in inter-DU cell change. The MAC context contents of relevance will be related to supporting the DRBs and SRBs (configuration of MAC and RLC). Further, the L1 measurement configuration will be part of the MAC context that is of interest to transfer. The L1 measurement may remain the same in the target, with some updates to be done by the target as removing and adding neighbor cells to measure.

Other parts of the MAC context, such as L1 configurations, may differ and may need to be updated after or with the RACH message 4 contention resolution.

In an Inter-DU context, the UE lacks the configuration for the recovery cell, which also doesn't belong to the same DU as the previously serving cell. In case of no CU-DU split, this MAC MM of the target cell does not have control over the source cell. FIG. 19 shows how the UE context is made known to the target DU/MAC MM of the target cell. In the figure, differences to recovery case 1 are at. For example, line 5, lines 12-16 and line 18.

In this regard, while the UE does not have the configurations of the recovery cell 2, it is aware that cell 2 supports MAC-level mobility. Target DU or MAC MM provides an update to the MAC configuration after RACH message 4 (or bundled with it). For the actual context retrieval, two options can be used. In Option 1, a Target DU queries the CU. This may be aided by the source DU earlier providing a version of the UE context to the CU for future faster retrieval. Context provided by the CU/RRC can be considered authoritative only if additionally confirmed by the DU/MAC MM. In option 2, the UE MAC context is retrieved only as needed from the source DU/source MAC MM via a direct DU-DU interface. This is possible only under the assumption that a proprietary or future standardized DU-DU/source-target MAC MM interface is available. Source DU in principle is aware of the last UE MAC context (and also the last cell to which the UE was connected). Hence, MAC context provided by source DU/MAC MM can be considered authoritative.

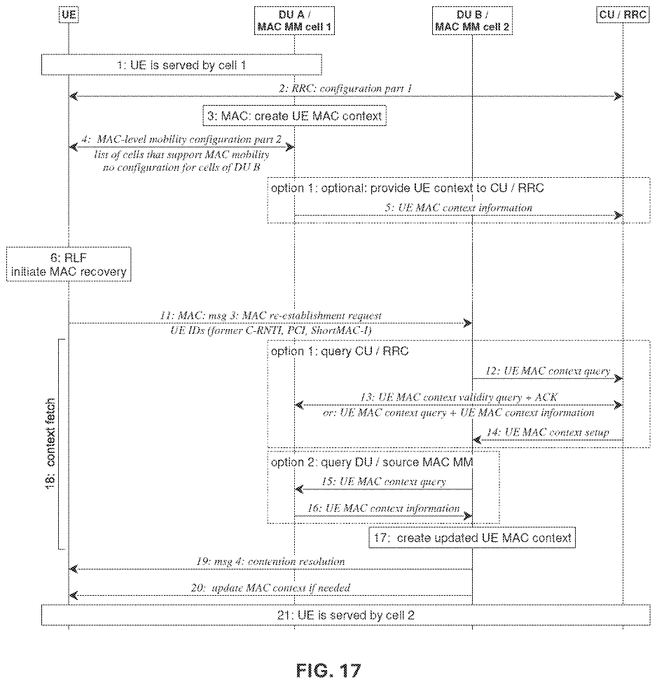

FIG. 17 shows at least some details of a context fetch at the network. In FIG. 17, the UE knows MAC mobility is possible at the target (e.g., non-blind recovery) but does not have the configuration information. The target does not have the UE MAC context. This is an inter-DU and inter-MAC MM scenario. As shown, in lines 1-4, the UE is made aware which target cells support MAC re-establishment, but does not have the configurations for target cells. In line 5, this is an optional step for option 1. Here, the source DU/MAC MM provides to the CU already a copy of the UE MAC context. The purpose is to accelerate a later possible recovery. It is optional because, at recovery time, the target DU can also query the context via the CU. This message can be implemented as a new F1AP “UE MAC context information” resembling a “UE context setup request”, but from DU to CU and not for creating a context but for information.

In line 6, MAC re-establishment is initiated instead of RRC re-establishment. RACH messages 1 are left out of the MSC for brevity. In line 11, message 3 of CBRA CRACH is provided.

Option 1 is shown. In this regard, in line 12, a target DU seeks to retrieve the UE's MAC context via the CU. This requires a new type of message, containing information such as UE IDs and indication that it is about the MAC context. This requires a new F1AP message “UE MAC context query”. In line 13, that CU knows the DU that the UE's source cell belongs to. It, therefore, can query the source DU for the MAC context. If, in option 1, the optional line 5 was used, the message exchange here can be reduced to whether the earlier provided MAC context is still valid. (new message MAC context validity query, followed by ACK or updated MAC context). If the optional line 5 was not used, the CU sends a new message type “MAC UE context query”, followed by the DU providing the UE MAC context “UE MAC context info”. The content of the latter would be similar to a “UE context setup”, but from DU to CU, focusing on MAC context, and not intended to create a context in the CU. In line 14, the target DU is provided with the UE MAC context. This can be done with a UE context setup request, focusing on MAC context.

For Option 2, it is assumed that the target DU is aware of the physical cell IDs (PCIs) of its neighbor DUs (it could also ask that piece of information from the CU), and that it has an interface to the neighbor DU. In lines 15 and 16, the MAC context is retrieved. The message 16 can be labeled “UE MAC context information”, given that DU1 is not controlling DU2 and cannot direct it to perform a “setup”. In line 17, the target DU creates own MAC configuration. Now that the target DU knows what kind of MAC configuration is present in the UE, it can determine what kind of update to the MAC context is needed at the UE. In line 18, contention resolution is provided. In line 19, the UE is updated with MAC configuration, if needed, and alternatively can be bundled with line 18. In line 20, after contention resolution, the UE is served by the recovery cell. Optionally, the MAC MM may also inform the RRC about the cell switch (not shown in figure). Optionally, the MAC MM may also inform the RRC about the updated MAC configuration, such that the RRC context is updated as well (not shown in figure), which could accelerate a future inter-CU recovery.

As mentioned earlier, in some cases, the UL grant in the RAR is of sufficient size to accommodate either a MAC message 3 or an RRC message 3. This is for the case where a legacy UE does not understand and ignores the indication contained in message 2, and wants to send RRC Re-establishment in message 3, and the RRC re-establishment message has a different size than MAC re-establishment. In at least one form, the MAC re-establishment request (see below) has the same size as the RRC re-establishment request, but the presently described embodiments are not so limited. Length may be impacted by implementations and environments of use.

Recall, for an RRC re-establishment request, the RRC contents are sent via RLC-TM (transparent mode) and are not ciphered, on SRB0, logical channel CCCH. TS 38.321 section 6.12 specifies that an UL CCCH SDU is encapsulated with a MAC subheader (LX)/R/LCID.

In order to identify the MAC re-establishment as a MAC terminated message, according to the presently described embodiments, in at least one form, a new LCID may be defined. The LCID in the table of TS 38.321 may be modified to add a MAC-Reestablishment Request at 42.

TABLE 1
modification of LCID table to define a new
MAC CE “MAC re-establishment request”
TS 38.321 Table 6.2.1-2: Values of LCID for UL-SCH
when the LX field is not present or is set to 0

| Codepoint/ | |
|---|---|
| Index | LCID values |
| 0 | CCCH of size 64 bits, except for an (e)RedCap UE |
| 1-32 | Identity of the logical channel of DCCH and DTCH |
| 33 | Extended logical channel ID field (two-octet eLCID field) |
| 34 | Extended logical channel ID field (one-octet eLCID field) |
| 35 | CCCH of size 48 bits for a RedCap UE |
| 36 | CCCH of size 64 bits for a RedCap UE |
| 37 | SL LBT failure |
| 38-41 | Reserved |
| 42 | MAC Re-establishment Request |
| 43 | Truncated Enhanced BFR (one octet Cᵢ) |
| 44 | Timing Advance Report |
| 45 | Truncated Sidelink BSR |
| 46 | Sidelink BSR |
| 47 | Reserved |
| 48 | LBT failure (four octets) |
| 49 | LBT failure (one octet) |
| 50 | BFR (one octet Cᵢ) |
| 51 | Truncated BFR (one octet Cᵢ) |
| 52 | CCCH of size 48 bits, except for an (e)RedCap UE |
| 53 | Recommended bit rate query |
| 54 | Multiple Entry PHR (four octets Cᵢ) |
| 55 | Configured Grant Confirmation |
| 56 | Multiple Entry PHR (one octet Cᵢ) |
| 57 | Single Entry PHR |
| 58 | C-RNTI |
| 59 | Short Truncated BSR |
| 60 | Long Truncated BSR |
| 61 | Short BSR |
| 62 | Long BSR |
| 63 | Padding |

NOTE:
CCCH of size 48 bits and CCCH of size 64 bits are referred to as CCCH and CCCH1, respectively, in TS 38.331 [5].

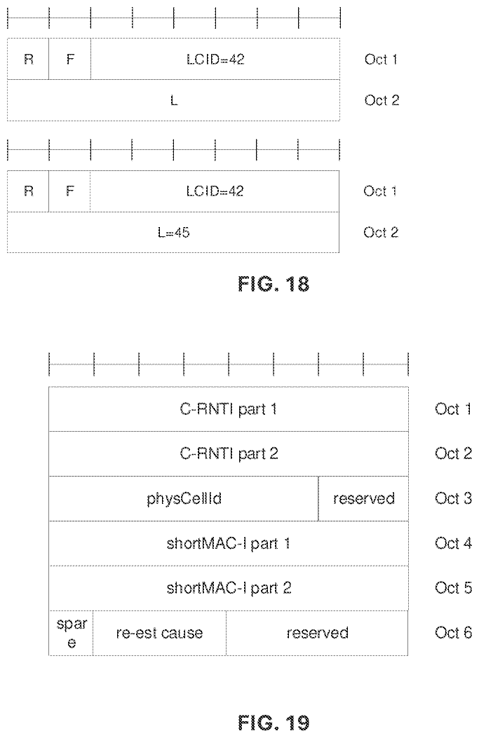

With reference to FIG. 18, a sub-header, e.g., a MAC re-establishment request sub-header, is shown where LCID indicates the type and L indicates the length of the payload. This header will be followed by the MAC SDU carrying the payload. The payload design may be done as follows: the message is sent, as message 1 and 2, without ciphering, and contains the same elements as RRC message 3, including a Source C-RNTI, a Source PCI, a ShortMAC-I, and a Reestablishment cause. The causes could be one of those known from RRC-RLF such as reconfiguration failure, handover failure or other failure. In principle, two bits are sufficient to encode the cause, however, in FIG. 19 below, 3 bits are used.

As an alternative to no ciphering, the payload is ciphered with the key (either K_RRC_I, or MAC ciphering) of the source cell, similar to ciphering of an RRC re-establishment message.

Overall, about 45 bits are needed, which can fit well to a MAC-CE. FIG. 19 shows a MAC service data unit (SDU) design for the MAC re-establishment request.

The source C-RNTI and source PCI will aid the new cell to identify the UE and retrieve its context, whereas the ShortMAC-I allows the target to verify the UE's identity. The network shall acknowledge the reception of this MAC message. If message 3 fits into a single Transport Block (TB), a HARQ ACK is sufficient. If message 3 does not fit into a single TB, the network shall acknowledge using DCI or a DL MAC CE. Alternatively, the UE may assume an ACK when it receives message 4. The UE shall resend this MAC CE until it has received a positive ACK (or timer or re-tx count and then go again into cell-reselection). Note: RRCReestablishment is carried in an UL CCCH message and does not have an RRC transaction identifier. Hence, also this MAC re-establishment is designed without a transaction identifier.

Recall, in legacy CBRA RACH, message 4 serves contention resolution and may be for instance in form of a MAC CE. The same can be used also for MAC re-establishment. Additional MAC level configurations that could be bundled and sent alongside message 4 are out of scope of this invention.

The example described system and method can be implemented in a variety of manners to achieve the functionality described herein according to the presently described embodiments. The system and functionality could vary based on the implementation and/or the environment of use.

As but one example, the presently described embodiments may be implemented in an environment where a RLF is detected, or declared, by the UE based on any of a variety of criteria that will be apparent to those of skill in the art. For example, the UE declares Radio Link Failure (RLF) when at least one of the following criteria are met, although this detection or declaration is not so limited. These example criteria are: 1) expiry of a radio problem timer started after indication of radio problems from the physical layer (if radio problems are recovered before the timer is expired, the UE stops the timer), 2) expiry of a timer started upon triggering a measurement report for a measurement identity for which the timer has been configured while another radio problem timer is running, 3) random access procedure failure, 4) radio link control (RLC) failure, 5) detection of consistent uplink listen before talk (LBT) failures for operation with shared spectrum channel access, or 6) for integrated access backhaul mobile termination (IAB-MT), the reception of a backhaul radio link failure (BH RLF) indication received from its parent node.

In but one example of a further environment and/or implementation, after detection or declaration of RLF, the UE may remain in a radio resource control connected state (e.g., RRC_CONNECTED) and determine if any special conditions exist, such as dual active protocol stack (DAPS) handover, conditional handover (CHO) or LTM (e.g., master cell group lower layer triggered mobility, MCG LTM).

In the case of DAPS handover, for RLF in the source cell, the UE stops any data transmission or reception via the source link and releases the source link but maintains the source RRC configuration. If handover failure is then declared at the second or target cell, the UE selects a suitable cell and then initiates RRC re-establishment. The UE enters RRC_IDLE if a suitable cell was not found within a certain time after handover failure was declared.

In the case of CHO, for RLF in the source cell, the UE selects a suitable cell, and if the selected cell is a CHO candidate, and if network configured the UE to try CHO after RLF, then the UE attempts CHO execution once, otherwise re-establishment is performed. The UE enters RRC_IDLE if a suitable cell was not found within a certain time after RLF was declared.

In the case of LTM, e.g., MCG LTM, for RLF in the source cell, the UE selects a suitable cell and, if the selected cell is an LTM candidate cell and if network configured the UE to try LTM after RLF, then the UE attempts RACH-based LTM execution once, otherwise re-establishment is performed. The UE enters RRC_IDLE if a suitable cell was not found within a certain time after RLF was declared.

Otherwise, for RLF in the serving (or source) cell or in case of DAPS handover, for RLF in the second or target cell before releasing the source cell, the UE selects a suitable cell (e.g., the selected second cell or target cell) and then, in the case of the suitable cell (potentially) supporting MAC re-establishment (e.g., based on determining that the selected second cell supports medium access control re-establishment), initiates MAC re-establishment according to the presently described embodiments or variations thereof that might be implemented to suit the implementation and/or environment of use. In the case of the selected/suitable cell not supporting MAC re-establishment (e.g., based on determining that the selected second cell does not support medium access control re-establishment), the UE initiates RRC re-establishment. The UE enters RRC_IDLE if a suitable cell was not found within a certain time after RLF was declared.

Further, it will be appreciated that methods according to the presently described embodiments may be implemented in variety of manners, including those methods described herein such as the methods described in connection with the system and flow diagrams.

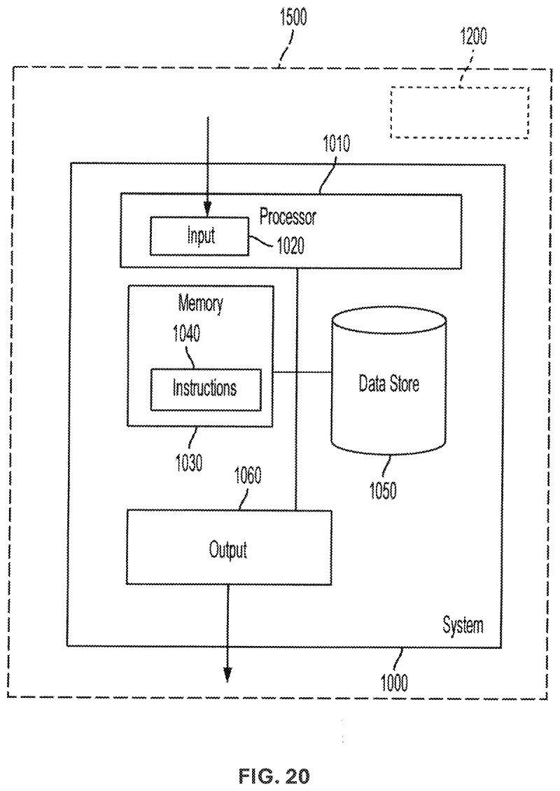

With reference now to FIG. 20, a system 1000 is shown. It should be appreciated the system 1000 may take a variety of forms and be implemented in a variety of environments. For example, the system 1000 may be implemented in mobile devices or a suitable network element 1500 in a communications network to provide a suitable function in accord with the presently described embodiments. In this regard, the mobile or network element 1500 may take a variety of forms. In any suitable form, the mobile or network element may also be provided with an antenna or antenna system 1200 having, for example, antenna ports and other suitable features.

The system 1000 is provided with appropriate control and processing capability. The system 1000 may be implemented to provide processing and/or control to the systems and methods described herein, including in connection with FIGS. 8-19 herein, as those of skill in the art will appreciate. In one form, the system 1000 includes a processor or controller (or, in some example forms, multiple processors or controllers) 1010 to control or be implemented as, among other functions and hardware, a CPU or its functions according to the presently described embodiments. The processor includes an input unit 1020 to receive data and information. Of course, a memory unit 1030, or several memory units, are included in the system 1000. In this regard, the presently described embodiments, in at least one example, include suitable software program(s) (e.g., instructions and/or code 1040 which are stored on the at least one memory 1030) which, when executed by at least one processor, cause the processor and/or associated elements of the system to implement the method(s) according to the presently described embodiments. The system 1000 also includes a data storage unit 1050 and an output unit 1060.

It will be appreciated that the memory unit 1030 and data storage unit 1050 may take a variety of suitable forms to implement the presently described embodiments that will be apparent to those skilled in the art, including non-transitory computer readable media. The memory unit 1030 and data storage unit 1050 may be separate elements, combined elements or appropriately distributed, depending on the application. These units 1030 and 1050 may also be provided integrally with processor 1010 (or other processing elements) or fabricated and/or maintained separately therefrom.

Also, it will be appreciated that the structures and procedures shown above are only a representative example of embodiments that can be used to facilitate embodiments described above. In this regard, the various embodiments described in the examples above may be implemented using any suitable circuitry, hardware, and/or software modules that interact to provide particular results. One of skill in the computing arts can readily implement such described functionality, either at a modular level or as a whole, using knowledge generally known in the art. For example, the methods described herein may be used to create computer-readable instructions/code for execution by a processor. Such instructions may be stored on a non-transitory computer-readable medium and transferred to, for example, the processor for execution as is known in the art.

In this regard, it should be appreciated that the processor and/or controller 1010 is merely an example—it may take a variety of forms. For example, the above-described methods and/or techniques can be implemented on a system using well-known computer processors, memory units, storage devices, computer software, and other components. As shown in the example representation of such a system, the system 1000 includes at least one processor 1010 which receives data at an input module 1020 and controls the overall operation of the system 1000 by executing computer program instructions which define such operation. The computer program instructions may be stored in at least one storage device or memory 1030 (e.g., a magnetic disk or any other suitable non-transitory computer readable medium or memory device) and loaded into another memory (not shown) (e.g., a magnetic disk or any other suitable non-transitory computer readable medium or memory device), or another segment of memory 1030, when execution of the computer program instructions is desired. Thus, the methods described herein may be defined by the computer program instructions 1040 stored in the memory 1030 and controlled by the processor 1010 executing the computer program instructions 1040.

Also, according to various embodiments, FIG. 20 is an example representation of possible components of a system including a processor for illustrative purposes. Of course, the system may include other components. Also, the system 1000 is illustrated as primarily a single device or system. However, the system 1000 may be implemented as more than one device or system and, in some forms, may be a modular or distributed system with components or functions suitably distributed in, for example, a network or in various locations.

The exemplary embodiments have been described with reference to the example embodiments. Obviously, modifications and alterations will occur to others upon reading and understanding the preceding detailed description. It is intended that the exemplary embodiments be construed as including all such modifications and alterations insofar as they come within the scope of the appended claims or the equivalents thereof.

1. An apparatus implemented in user equipment, the apparatus comprising:
at least one processor; and,
at least one memory having stored thereon code or instructions that, when executed by the at least one processor, cause the apparatus to:
detect a radio link failure in a first cell, wherein the first cell is a source cell,
perform cell (re-)selection by the user equipment to select a second cell,
transmit a random access message to the selected second cell,
receive via the selected second cell a random access response comprising a medium access control level message from the selected second cell and an uplink grant, and
in response to determining that the selected second cell supports medium access control re-establishment, transmit towards the selected second cell a medium access control re-establishment request comprising user equipment identifiers including a source cell radio network temporary identifier, a source physical cell identification, and information to verify the user equipment identity.

2. The apparatus as set forth in claim 1, wherein the apparatus is further caused to:
receive from a network node information relating to performance of medium access control re-establishment.

3. The apparatus as set forth in claim 2 wherein the information relating to performance of medium access control re-establishment comprises a list of cells configured to perform medium access control re-establishment.

4. The apparatus as set forth in claim 2 wherein the information relating to performance of medium access control re-establishment comprises information on medium access control resources to perform medium access control re-establishment.

5. The apparatus as set forth in claim 2 wherein the information relating to performance of medium access control re-establishment comprises information allowing for receipt of a type identifier for medium access control re-establishment.

6. The apparatus as set forth in claim 1 wherein the apparatus is further caused to receive from the selected second cell an acknowledgement of the medium access control re-establishment request.

7. The apparatus as set forth in claim 1 wherein the apparatus is further caused to receive context resolution from the selected second cell.

8. The apparatus as set forth in claim 1 wherein the apparatus is further caused to receive a context update from the selected second cell.

9. The apparatus as set forth in claim 1 wherein the apparatus is further caused to establish a radio link connection to the selected second cell.

10. The apparatus as set forth in claim 1 wherein the network node includes a medium access control mobility manager.

11. The apparatus as set forth in claim 1 wherein the information to verify the user equipment identity is a ShortMAC element.

12. The apparatus as set forth in claim 1 wherein the apparatus is further caused to determine any of the following conditions: dual active protocol stack (DAPS) handover, conditional handover (CHO) or LTM.

13. An apparatus implemented in user equipment, the apparatus comprising:
at least one processor; and,
at least one memory having stored thereon code or instructions that, when executed by the at least one processor, cause the apparatus to:
detect a radio link failure in a first cell, wherein the first cell is a source cell,
perform cell (re-)selection by the user equipment to select a second cell,
in response to determining that none of the following conditions is applicable: dual active protocol stack (DAPS) handover, conditional handover (CHO) or LTM,
initiate medium access control re-establishment based on determining that the selected second cell supports medium access control re-establishment, and
initiate radio resource control re-establishment based on determining that the selected second cell does not support medium access control re-establishment.
